(19) United States
(12) Patent Application Publication
(10) Pub. No.: US 2010/0001577 A1
(43) Pub. Date: Jan. 7, 2010

(54) Brake system

(75) Inventor: Kunimichi Hatano, Saitama (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/455,668

(22) Filed: Jun. 4, 2009

(30) Foreign Application Priority Data
Jul. 7, 2008 (JP) 2008-177170

(51) Int. Cl. B60T 13/74

(52) U.S. Cl. 303/3

(57) ABSTRACT

A brake system including: a master cylinder that generates brake fluid pressure in response to a braking action of a driver, a wheel cylinder that brakes a wheel when actuated by brake fluid pressure, and an electric fluid pressure generator which also generates brake fluid pressure, is connected to the master cylinder through a first fluid passage, and is connected to the wheel cylinder through a second fluid passage. The electric fluid pressure generator being actuated to generate brake fluid pressure by an electric signal corresponding to the braking action of the driver. The system also includes an opening-closing valve that allows and prevents a communication through the first fluid passage and a controller that controls operation of the electric fluid pressure generator and operation of the opening-closing valve. When ending a braking action of the wheel cylinder, the controller closes the opening-closing valve and makes the electric fluid pressure generator output negative fluid pressure to the second fluid passage

### CROSS-REFERENCE TO RELATED APPLICATIONS

The present invention claims priority under 35 USC § 119 based on Japanese patent application No. 2008-177170, filed 7 Jul. 2008. The subject matter of this priority document is incorporated by reference herein.

### BACKGROUND OF THE INVENTION

1. Field of the Invention

The present invention relates to a brake system which includes: a master cylinder that generates brake fluid pressure in response to a braking action of a driver; a wheel cylinder actuated by fluid pressure for braking a wheel; an electric fluid pressure generator for generating fluid pressure that is connected to the master cylinder through a first fluid passage and that is connected to the wheel cylinder through a second fluid passage, the electric fluid pressure generator being actuated to generate brake fluid pressure by an electric signal corresponding to the braking action of the driver; an opening-closing valve that selectively allows and prevents communication through the first fluid passage; and a controller that controls operation of the electric fluid pressure generator and operation of the opening-closing valve.

2. Description of the Related Art

Japanese Patent Application Laid-open No. 2005-343366 discloses a brake system of the type referred to as a brake by wire (BBW) brake system, which converts a braking action of a driver into an electrical signal used to actuate a motor cylinder for electrically generating fluid pressure, whereby a wheel cylinder can be actuated by brake fluid pressure generated by the motor cylinder.

Suppose a situation, in such a BBW brake system, where the wheel cylinder is actuated by the brake fluid pressure generated by the action of the motor cylinder, and then the action of the motor cylinder is stopped. In this case, a piston of the wheel cylinder continues to be in contact with a brake disc, thereby causing braking drag. This is undesirable as it results in poor fuel economy, excessive wear of the brake disc, etc.

### SUMMARY OF THE INVENTION

The present invention has been made in view of the above-described circumstances, and it is an object thereof to prevent a braking drag of a wheel cylinder after performing a braking operation by a brake fluid pressure generated by an electric fluid pressure generator such as a motor cylinder.

In order to achieve the object, according to a first aspect and feature of the present invention, there is provided a brake system comprising: a master cylinder that generates brake fluid pressure in response to a braking action of a driver; a wheel cylinder that brakes a wheel when actuated by brake fluid pressure; an electric fluid pressure generator which also generates brake fluid pressure, is connected to the master cylinder through a first fluid passage, and is connected to the wheel cylinder through a second fluid passage; the electric fluid pressure generator being actuated to generate brake fluid pressure by an electric signal corresponding to the braking action of the driver; an opening-closing valve that allows and prevents a communication through the first fluid passage; and a controller that controls operation of the electric fluid pressure generator and operation of the opening-closing valve; wherein when ending a braking action of the wheel cylinder, the controller closes the opening-closing valve and makes the electric fluid pressure generator output negative fluid pressure to the second fluid passage.

With the brake system of the present invention described above, once the wheel cylinder is actuated by outputting, to the second fluid passage, the fluid pressure generated by the electric fluid pressure generator, the action of the wheel cylinder is stopped in the following way. The opening-closing valve in the first fluid passage is closed to prevent the communication between the electric fluid pressure generator and the master cylinder. While the communication is prevented, the electric fluid pressure generator makes the brake fluid pressure, which is output to the second fluid passage, negative. Accordingly, such negative pressure can be securely generated by making the opening-closing valve block the inflow of the brake fluid from the master cylinder into the electric fluid pressure generator via the first fluid passage. As a consequence, the occurrence of braking drag of the wheel cylinder can be avoided.

According to a second aspect and feature of the present invention, in addition to the first aspect and feature, the electric fluid pressure generator includes a piston slidably fitted into a cylinder main body and an inlet port opened in the cylinder main body communicating with the first fluid passage, the electric fluid pressure generator generates the brake fluid pressure when the piston moves forward beyond the inlet port, and for stopping the action of the wheel cylinder, the piston is moved backward beyond the inlet port to a predetermined position.

With the configuration described above, the electric fluid pressure generator is configured to generate the brake fluid pressure when the piston moves forward beyond the inlet port, the piston being moved forward by the electric motor, and the piston is slidably fitted into a cylinder main body in which the inlet port communicating with the first fluid passage is opened. In addition, for stopping the action of the wheel cylinder, the piston is moved backward beyond the inlet port to the predetermined position. Accordingly, while the opening-closing valve is closed to block the inflow of the brake fluid from a side of the master cylinder into the electric fluid pressure generator, the brake fluid pressure of the second fluid passage can reliably be reduced. Consequently, the occurrence of braking drag in the wheel cylinder can be avoided.

According to a third aspect and feature of the present invention, in addition to the first aspect and feature, in the event of a malfunction of the electric fluid pressure generator, the opening-closing valve is opened.

With the configuration described above, in the event of a malfunction of the electric fluid pressure generator, the opening-closing valve is opened. Accordingly, the master cylinder can communicate with the wheel cylinder via the electric fluid pressure generator. Consequently, the master cylinder can generate brake fluid pressure to actuate the wheel cylinder so as to provide a failsafe backup for the malfunctioning electric fluid pressure generator.

According to a fourth aspect and feature of the present invention, in addition to the third aspect and feature, the opening-closing valve is a normally-open solenoid valve that is automatically opened in the event of a power-supply failure.

With the configuration described above, the opening-closing valve is the normally-open solenoid valve that is automatically opened in the event of a power-supply failure, in such an event, the brake fluid pressure generated by the master cylinder can be used as a backup for the fluid pressure that would otherwise be generated by the normally-operating electric fluid pressure generator.

According to a fifth aspect and feature of the present invention, in addition to the first aspect and feature, a stroke simulator is disposed between the opening-closing valve and the master cylinder.

With the configuration described above, the stroke simulator is disposed between the opening-closing valve and the master cylinder. Accordingly, when the braking operation is carried out by using the brake fluid pressure generated by the electric fluid pressure generator, the opening-closing valve is closed and thus the brake fluid is supplied from the master cylinder to the stroke simulator. Consequently, no uncomfortable pedal feeling is experienced by the driver.

According to a sixth aspect and feature of the present invention, in addition to the first aspect and feature, an ABS is disposed between the electric fluid pressure generator and the wheel cylinder.

With the configuration described above, an ABS is disposed between the electric fluid pressure generator and the wheel cylinder. Accordingly, when the brake operates while the vehicle with the brake travels on a road surface of a low friction coefficient, the wheel can be prevented from locking. Consequently, the braking distance can be shortened.

Note that a slave cylinder 23 in the exemplary embodiment corresponds to the electric fluid pressure generator of the present invention, and an electronic control unit U in the exemplary embodiment corresponds to the controller of the present invention.

The above-described and other objects, characteristics, and advantageous effects of the present invention will become apparent through the detailed description of preferred embodiment to be given with reference to the accompanying drawings.

### BRIEF DESCRIPTION OF THE DRAWINGS

FIGS. 1 to 4 show an exemplary embodiment of a brake system according to the present invention:

FIG. 1 is a fluid-pressure-circuit diagram of the vehicle brake system under normal operation;

FIG. 2 is an enlarged cross-sectional diagram of a part of a slave cylinder of the vehicle brake system according to an exemplary embodiment of the present invention;

FIG. 3 is a block diagram of a control system of the vehicle brake system according to an exemplary embodiment of the present invention; and

FIG. 4 is a fluid-pressure-circuit diagram corresponding to FIG. 1, except that the vehicle brake system is under abnormal operation.

### DESCRIPTION OF THE PRESENT EMBODIMENT

An exemplary embodiment of the present invention will be described with reference to attached drawings.

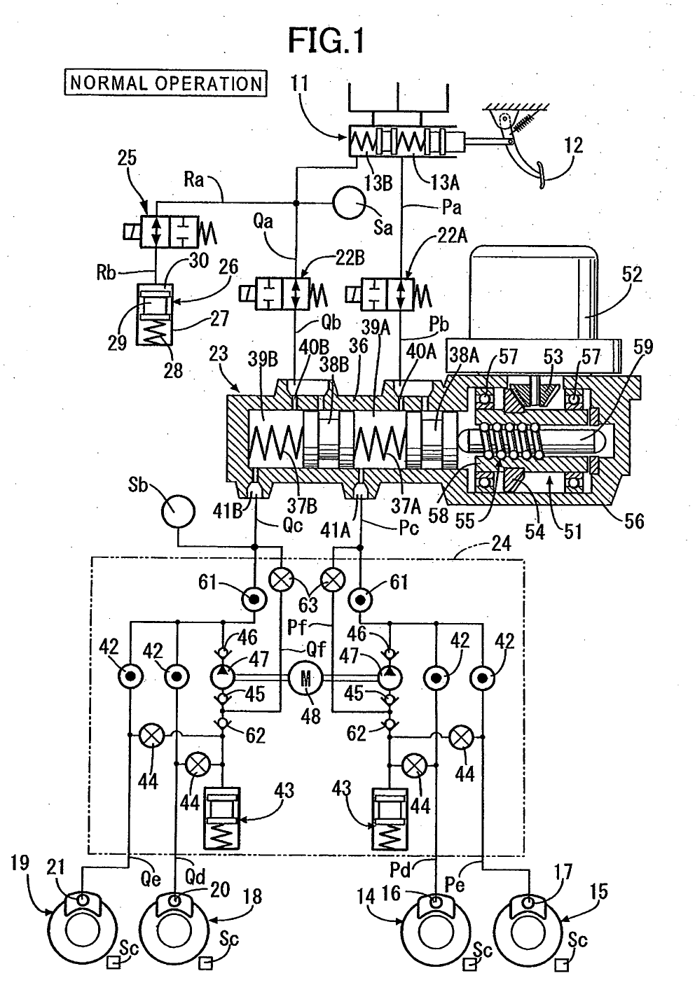

As shown in FIG. 1, a tandem master cylinder 11 has two fluid pressure chambers 13A and 13B which output brake fluid pressure according to a force applied to a brake pedal 12 by a driver treading on the brake pedal 12. One of the fluid pressure chambers 13A is connected to wheel cylinders 16 and 17 of disc brake devices 14 and 15 for braking, for example, a left front wheel and a right rear wheel through fluid passages Pa, Pb, Pc, Pd, and Pe. The other fluid pressure chamber 13B is connected to wheel cylinders 20 and 21 of disc brake devices 18 and 19 for braking, for example, a right front wheel and a left rear wheel through fluid passages Qa, Qb, Qc, Qd, and Qe.

An antilock brake system (ABS) 24 for controlling a locking of vehicle wheel is provided between the fluid passages Pc, Qc and the fluid passages Pd, Pe; Qd, Qe. The ABS 24 has Vehicle Stability Assist (VSA) function for enhancing steering stability of a vehicle by generating a difference of braking force between left and right wheels.

An opening-closing valve 22A, which is a normally-open solenoid valve, is provided between the fluid passages Pa and Pb. An opening-closing valve 22B, which is a normally-open solenoid valve, is provided between the fluid passages Qa and Qb. A slave cylinder 23 is provided between the fluid passages Pb, Qb and the fluid passages Pc, Qc.

A reaction force permission valve 25, which is a normally-closed solenoid valve, is connected between a fluid passage Ra branching from the fluid passage Qa and a fluid passage Rb. A stroke simulator 26 is connected to the fluid passage Rb. The stroke simulator 26 has a cylinder 27 and a piston 29 slidably fitted in the cylinder 27 while being urged by a spring 28. A fluid chamber 30, formed on the side of the piston 29 opposite from the spring 28, communicates with the fluid passage Rb.

An actuator 51 of the slave cylinder 23 has a drive bevel gear 53 provided on the rotating shaft of an electric motor 52, a follower bevel gear 54 meshing with the drive bevel gear 53, and a ball screw mechanism 55 operated by the follower bevel gear 54. A sleeve 58 is rotatably supported in an actuator housing 56 via a pair of ball bearings 57. An output shaft 59 is coaxially arranged on an inner periphery of the sleeve 58. The follower bevel gear 54 is arranged on an outer periphery of the sleeve 58.

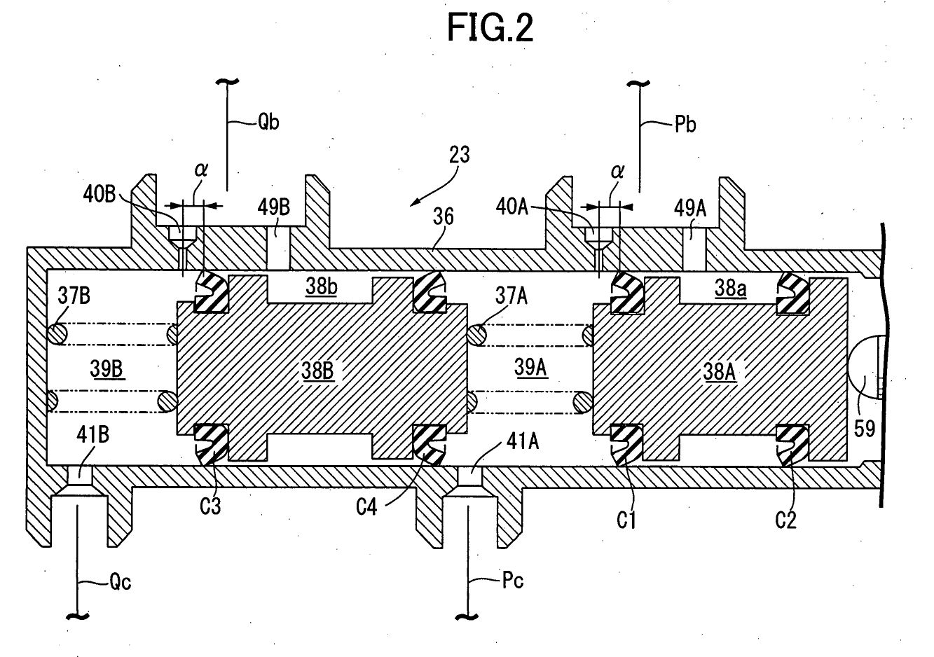

As shown in FIG. 2, a pair of pistons 38A and 38B urged in a backward direction by a pair of return springs 37A and 37B are slidably disposed in a cylinder body 36 of the slave cylinder 23. A pair of fluid pressure chambers 39A and 39B are defined on the front faces of the pistons 38A and 38B, respectively. A front end of the output shaft 59 abuts on a rear end of the rear piston 38A. One of the fluid pressure chambers 39A communicates with the fluid passages Pa, Pc via inlet port 40A and outlet port 41A respectively, while the other fluid pressure chamber 39B communicates with the fluid passages Qa, Qc through inlet port 40B and outlet port 41B respectively.

A reservoir chamber 38a for preventing air from entering to the fluid pressure chamber 39A is formed on an outer periphery of the piston 38A, and a reservoir chamber 38b for preventing air from entering to the fluid pressure chamber 39B is formed on an outer periphery of the piston 38B. The inlet port 40A of the fluid pressure chamber 39A and a supply port 49A of the reservoir chamber 38a communicate with the fluid pressure chamber 13A of the master cylinder 11, and the outlet port 41A of the fluid pressure chamber 39A communicates with the wheel cylinders 16 and 17. The inlet port 40B of the fluid pressure chamber 39B and a supply port 49B of the reservoir chamber 38b communicate with the fluid pressure chamber 13B of the master cylinder 11, and the outlet port 41B of the fluid pressure chamber 39B communicates with the wheel cylinders 20 and 21.

A first cup seal C1 is provided to the front end portion of the piston 38A so as to face forward (i.e., so as to produce its sealing effects when the piston 38A moves forward), and a second cup seal C2 is provided to the rear end portion of the piston 38A so as to face forward. A third cup seal C3 is provided to the front end portion of the piston 38B so as to face forward, and a fourth cup seal C4 is provided to the rear end portion of the piston 38B so as to face backward (i.e., so as to produce its sealing effects when the piston 38B moves backward).

When the pair of pistons 38A and 38B are at non-movable position (move-backward limit), an ineffective stroke α, which is larger than normal, is set between the first cup seal C1 and the inlet port 40A and an ineffective stroke α, which is larger than normal, is set between the third cup seal C3 and the inlet port 40B. Accordingly, when the pair of pistons 38A and 38B begin to move forward from the non-movable position, the first cup seal C1 and the third cup seal C3 do not block the inlet ports 40A and 40B immediately, but after advancing the ineffective stroke α, the cup seals C1 and C3 block the inlet ports 40A and 40B.

Referring back to FIG. 1, the structure of the ABS 24 arranged between the fluid passages Pc, Qc and the fluid passages Pd, Pe; Qd, Qe is of a well-known type. The ABS 24 has two systems structurally identical to each other: a system including the disc brake devices 14 and 15 for braking the left front wheel and the right rear wheel; and a system for the disc brake devices 18 and 19 for braking the right front wheel and the left rear wheel. Of these systems, the system for the disc brake devices 14 and 15 will be described as a representative. A pair of in-valves 42 and 42 comprising normally-open solenoid valves are provided between the fluid passage Pc and the fluid passages Pd, Pe. A pair of out-valves 44 and 44 comprising normally-closed solenoid valves are provided between the fluid passages Pd, Pe on the downstream side of the in-valves 42 and 42 and a reservoir 43. A fluid pressure pump 47 interposed between a pair of check valves 45 and 46 is provided between the reservoir 43 and the fluid passage Pc. The fluid pressure pump 47 is driven by an electric motor 48.

In order to exert the VSA function, the ABS 24 also has the following components: the regulator valves 61 and 61 comprising normally-open solenoid valves whose opening degrees can be arbitrarily controlled are respectively arranged before a position where the fluid passage Pc branches into the fluid passages Pd, Pe, and before a position where the fluid passage Qc branches into the fluid passages Qd, Qe. Check valves 62 and 62 are arranged in series with respect to the check valves 45 and 45. Suction valves 63 and 63 comprising normally-closed solenoid valves are arranged in the fluid passages Pf, Qf which branch from a position between the check valves 45 and 45 and the check valves 62 and 62 and leads to the liquid passages Pc, Qc upstream of the regulator valves 61 and 61.

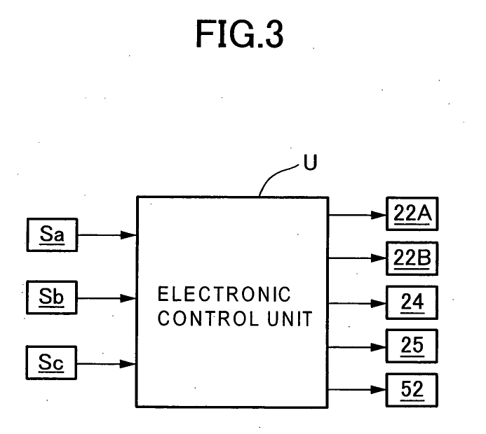

As shown in FIG. 3, the electronic control unit U is connected to: a fluid pressure sensor Sa provided in the fluid passage Qa between the master cylinder 11 and the slave cylinder 23; a fluid pressure sensor Sb provided in the fluid passage Qc between the slave cylinder 23 and the ABS 24; and wheel speed sensors Sc provided on each wheel. The electronic control unit U controls an operation of the opening-closing valves 22A and 22B, the reaction force permission valve 25 and the ABS 24 as well as the electric motor 52 of the slave cylinder 23.

Next, an operation of an exemplary embodiment of the present invention having the above-described arrangement will now be described.

In a normal operation of the system, as shown in FIG. 1, the opening-closing valves 22A and 22B, comprising normally-open solenoid valves, are demagnetized so as to be in an open state, and the reaction force permission valve 25, comprising a normally-closed solenoid valve, is magnetized so as to be in an open state. In this state, when the fluid pressure sensor Sa provided in the fluid passage Qa detects a depression on the brake pedal 12 by the driver, the actuator 51 of the slave cylinder 23 is operated. That is, when the electric motor 52 is driven in one direction, the output shaft 59 is advanced by the drive bevel gear 53, the follower bevel gear 54 and the ball screw mechanism 55, so that the pair of the pistons 38A and 38B urged by the output shaft 59 are advanced.

Now suppose that the pistons 38A and 38B shown in FIG. 2 start moving forward. In this case, the brake fluid in the fluid pressure chambers 39A and 39B continues to flow back to the master cylinder 11 respectively through the opened opening-closing valves 22A and 22B until the first and the third cup seals C1 and C3 move forward by as much distance as the ineffective stroke α and thus respectively close the inlet ports 40A and 40B. Accordingly, no brake fluid pressure is generated in either of the fluid pressure chambers 39A and 39B. Note that, once the pistons 38A and 38B start moving forward, it takes only a brief time for the first and the third cup seals C1 and C3 to close the inlet port 40A and 40B, respectively. Accordingly, the quick responsiveness of the braking will not be deteriorated.

And when the first cup seal C1 and the third cup seal C3 close the inlet ports 40A and 40B, the brake fluid is generated in the fluid pressure chambers 39A and 39B. This brake fluid is transmitted to the wheel cylinders 16, 17; 20, 21 of the disc brake devices 14, 15; 18, 19 to control each wheel.

At this time, the brake fluid output to the fluid passages Pa and Qa by the master cylinder 11 is shut off by the closed inlet ports 40A and 40B of the slave cylinder 23, but the brake fluid pressure generated in the other fluid pressure chamber 13B of the master cylinder 11 is transmitted to the fluid chamber 30 of the stroke simulator 26 through the opened reaction force permission valve 25 to move the piston 29 against the spring 28, thereby generating a pseudo pedal reaction force while permitting the stroke of the brake pedal 12 to eliminate an uncomfortable feeling to the driver.

During that time, the rotation angle of the electric motor 52 for the slave cylinder 23 is feedback-controlled so that the brake fluid pressure generated by the slave cylinder 23 and detected by the fluid pressure sensor Sb provided in the fluid passage Qc has a value corresponding to the brake fluid pressure generated by the master cylinder 11 and detected by the fluid pressure sensor Sa provided in the fluid passage Qa, thereby generating the braking force in the disc brake devices 14, 15; 18, 19 according to the depressing force inputted by the driver on the brake pedal 12.

Suppose that while the wheels are each in the above-described braking state, the driver releases the depressed brake pedal 12 to stop the braking. When the fluid pressure sensor Sa provided in the fluid passage Qa detects the releasing of the brake pedal, the opening-closing valves 22A and 22B are excited so as to be closed. Accordingly, the closed opening-closing valves 22A and 22B cut the communication between the slave cylinder 23 and the master cylinder 11. In this state, the electric motor 52 of the actuator 51 of the slave cylinder 23 rotates in the reverse direction. The reverse rotation of the electric motor 52 is transmitted through the drive bevel gear 53, the follower bevel gear 54, and the ball screw mechanism 55 to make the output shaft 59 move backwards. The backward movement of the output shaft 59 allows the spring force of the return springs 37A and 37B to make the pair of pistons 38A and 38B move backwards.

When the backward movement of the pistons 38A and 38B and the first and the third cup seals C1 and C3 reach the positions of the inlet ports 40A and 40B, respectively, the brake fluid pressure of the wheel cylinders 16, 17; 20, 21 becomes zero. While the pistons 38A and 38B move further backwards by the distance of the ineffective stroke α, the cutting of the communication between the master cylinder 11 and the fluid pressure chambers 39A and 39B, by the closing of the opening-closing valves 22A and 22B, turns the brake fluid pressure in the fluid pressure chambers 39A and 39B to be negative pressure. Consequently, the pistons of the wheel cylinders 16, 17; 20, 21 are separated away from their respective brake discs without failure. Such separation can prevent the braking drag from occurring and contribute to an improvement in fuel consumption.

If the slave cylinder 23 becomes inoperable due to power failure and the like, the braking is performed by the brake fluid pressure generated by the mater cylinder 11 in place of the brake fluid pressure generated by the slave cylinder 23.

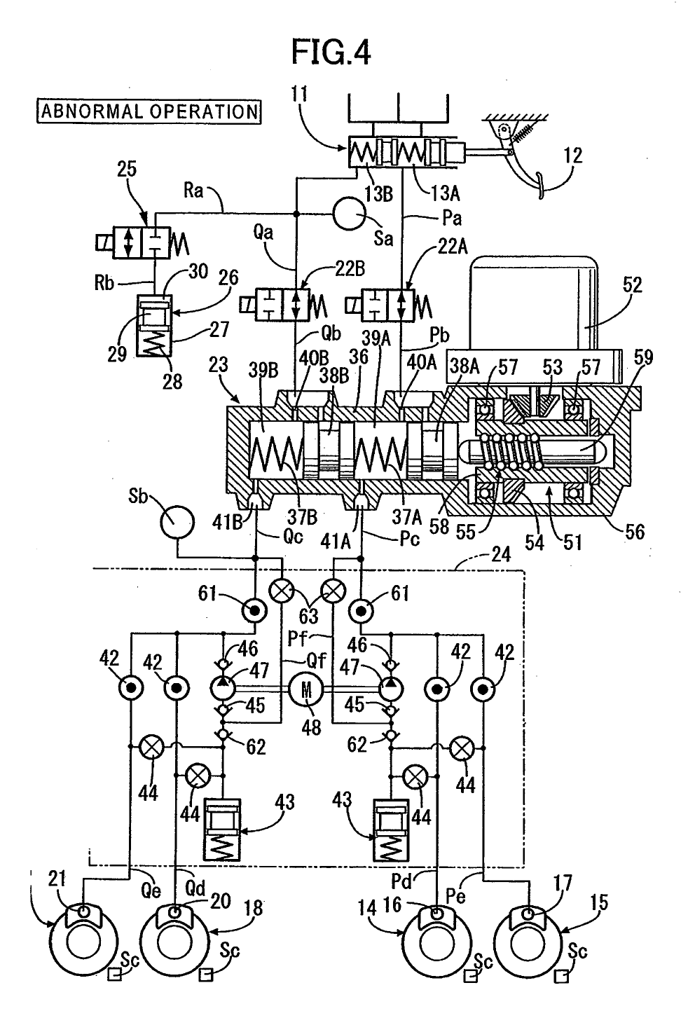

That is, in the event of power failure, as shown in FIG. 4, the opening-closing valves 22A and 22B, comprising normally-open solenoid valves, are automatically opened, and the reaction force permission valve 25, comprising a normally-closed solenoid valve, is automatically closed. In this state, the brake fluid pressure generated in the fluid pressure chambers 13A and 13B of the master cylinder 11 passes the opened opening-closing valves 22A and 22B, the fluid pressure chambers 39A and 39B of the slave cylinder 23, and the opened regulator valves 61 and 61 and the in-valves 42 of the ABS 24, without being absorbed by the stroke simulator 26; and can generate the braking force, without any problem, to the wheel cylinders 16, 17; 20, 21 of the disc brake devices 14, 15; 18, 19 of each wheel.

Next, the operation during the ABS control will be described. If slip ratio of any vehicle wheel is increased and a tendency of locking is detected based on the output from the wheel speed sensor Sc during braking under normal operation, the ABS 24 is operated in a state in which the slave cylinder 23 is maintained in the operating state, thereby preventing locking of the vehicle wheel.

That is, when any vehicle wheel has a tendency of locking, a pressure reducing operation is performed to release the brake fluid pressure in the wheel cylinder to the reservoir 43 by opening the out-valve 44 such that the transmission of the brake fluid pressure from the slave cylinder 23 is shut off by closing the in-valve 42 communicating with the wheel cylinder of the disc brake system of the wheel; and a pressure maintaining operation is subsequently performed to maintain the brake fluid pressure in the wheel cylinder by closing the out-valve 44, thereby reducing the braking force to avoid locking of the vehicle wheel.

When the vehicle wheel speed is thus recovered to reduce the slip ratio, a pressure increasing operation is performed to increase the brake fluid pressure in the wheel cylinder by opening the in-valve 42, thereby increasing the braking force for braking the vehicle wheel. When the wheel has a tendency of locking again due to this pressure increasing operation, the above-described pressure reducing, maintaining and increasing operation is performed again. The operation is repeatedly performed to generate the maximum braking force while preventing locking of the vehicle wheels. The brake fluid flowing into the reservoir 43 during this process is returned by the fluid pressure pump 47 to the fluid passages Pc and Qc on the upstream side.

During the above-described ABS control, the opening-closing valves 22A and 22B are magnetized so as to be closed, thereby preventing a fluid pressure fluctuation associated with the operation of the ABS 24 from being transmitted as a kickback from the master cylinder 11 to the brake pedal 12.

Next, the operation during the VSA control will be described. In the VSA control, the braking force can be controlled individually for the right wheels and the left wheels such that a yaw moment for suppressing over-steering is generated by operating the wheel cylinders of the turning outer wheels when an over-steering tendency occurs during the turning of the vehicle, and a yaw moment for suppressing under-steering is generated by operating the wheel cylinders of the turning inner wheels when the under-steering tendency occurs during the turning of the vehicle.

Specifically, as shown in FIG. 1, when the fluid pressure pumps 47, 47 are operated in a state where the suction valves 63, 63 are magnetized to be opened, the fluid pressure pumps 47, 47 suck the brake fluid from the reservoirs of the master cylinder 11 through the suction valves 63, 63, thereby generating brake fluid pressure on a side upstream of the in-valves 42. This brake fluid pressure is regulated to a predetermined level by magnetizing and controlling the regulator valves 61, 61 to a predetermined opening degree.

In this state, the in-valve 42 corresponding to a wheel which requires braking is opened so that the brake fluid pressure is transmitted to the wheel cylinder so as to operate the wheel cylinder to generate a braking force, while closing the in-valve 42 corresponding to a wheel which does not require braking so that the brake fluid pressure is not transmitted to the wheel cylinder. The control of increasing, decreasing and maintaining the brake fluid pressure transmitted to the wheel cylinders is performed by opening and closing the in-valves 42 and the out-valves 44 as in the case of the ABS control.

As described above, only one of the right and left wheels are braked under the VSA control, thereby generating a yaw moment in any direction to improve the operational stability of the vehicle.

Although an exemplary embodiment of the present invention has been described above, various modifications in design can be made thereto without departing from the scope of the present invention as set forth in the appended claims.

For example, the slave cylinder 23 used in the exemplary embodiment is not the only example of the electric fluid pressure generator of the present invention. Instead, the brake fluid pressure may be generated by making an electric motor drive a fluid pressure pump.

As another example, the ABS 24 used in the exemplary embodiment is not always necessary, and thus can be omitted.

What is claimed is:

1. A brake system comprising:
a master cylinder that generates brake fluid pressure in response to a braking action of a driver;
a wheel cylinder that brakes a wheel when actuated by brake fluid pressure;
an electric fluid pressure generator which also generates brake fluid pressure, is connected to the master cylinder through a first fluid passage, and is connected to the wheel cylinder through a second fluid passage;
the electric fluid pressure generator being actuated to generate brake fluid pressure by an electric signal corresponding to the braking action of the driver;
an opening-closing valve that allows and prevents communication through the first fluid passage; and
a controller that controls operation of the electric fluid pressure generator and operation of the opening-closing valve,
wherein when ending a braking action of the wheel cylinder, the controller closes the opening-closing valve and makes the electric fluid pressure generator output negative fluid pressure to the second fluid passage.

2. The brake system according to claim 1,
wherein the electric fluid pressure generator includes a piston slidably fitted into a cylinder main body and an inlet port opened in the cylinder main body communicating with the first fluid passage, the electric fluid pressure generator generates the brake fluid pressure when the piston moves forward beyond the inlet port, and
for stopping the action of the wheel cylinder, the piston is moved backward beyond the inlet port to a predetermined position.

3. The brake system according to claim 1, wherein in the event of a malfunction of the electric fluid pressure generator, the opening-closing valve is opened.

4. The brake system according to claim 3, wherein the opening-closing valve is a normally-open solenoid valve that is automatically opened in the event of a power-supply failure.

5. The brake system according to claim 1, further comprising a stroke simulator that is disposed between the opening-closing valve and the master cylinder.

6. The brake system according to claim 1, further comprising an ABS that is disposed between the electric fluid pressure generator and the wheel cylinder.

7. A brake system comprising:
a master cylinder that generates brake fluid pressure in response to a braking action of a driver;
a wheel cylinder that brakes a wheel when actuated by brake fluid pressure;
an electric fluid pressure generator which generates brake fluid pressure, is connected to the master cylinder through a first fluid passage, and is connected to the wheel cylinder through a second fluid passage;
the electric fluid pressure generator being actuated to generate brake fluid pressure by an electric signal corresponding to the braking action of the driver;
an opening-closing valve that allows and prevents communication through the first fluid passage; and
a controller that controls operation of the electric fluid pressure generator and operation of the opening-closing valve,
wherein when ending a braking action of the wheel cylinder, the controller closes the opening-closing valve and makes the electric fluid pressure generator output negative fluid pressure to the second fluid passage, and
wherein the controller controls the brake system such that the brake fluid pressure generated by the electric fluid pressure generator is transmitted to the wheel cylinder under normal operation of the system, and the brake fluid pressure of the master cylinder is transmitted to the wheel cylinder under abnormal operation of the system.

8. The brake system according to claim 7,
wherein the electric fluid pressure generator includes a piston slidably fitted into a cylinder main body and an inlet port opened in the cylinder main body communicating with the first fluid passage, the electric fluid pressure generator generates the brake fluid pressure when the piston moves forward beyond the inlet port, and
for stopping the action of the wheel cylinder, the piston is moved backward beyond the inlet port to a predetermined position.

9. The brake system according to claim 7, wherein in the event of a malfunction of the electric fluid pressure generator, the opening-closing valve is opened.

10. The brake system according to claim 9, wherein the opening-closing valve is a normally-open solenoid valve that is automatically opened in the event of a power-supply failure.

11. The brake system according to claim 7, further comprising a stroke simulator that is disposed between the opening-closing valve and the master cylinder.

12. The brake system according to claim 7, further comprising an ABS that is disposed between the electric fluid pressure generator and the wheel cylinder.
